(19) United States
(12) Patent Application Publication
(10) Pub. No.: US 2023/0389053 A1
(43) Pub. Date: Nov. 30, 2023

(54) SIDELINK RESOURCE SELECTION IN UNLICENSED SPECTRUM

(71) Applicant: QUALCOMM Incorporated, San Diego, CA (US)

(72) Inventors: Shuanshuan WU, San Diego, CA (US); Stelios STEFANATOS, San Diego, CA (US); Arthur GUBESKYS, San Diego, CA (US); Parisa CHERAGHI, Cambridge (GB)

(21) Appl. No.: 18/249,534

(22) PCT Filed: Dec. 9, 2021
(86) PCT No.: PCT/US2021/062605

§ 371 Date: Apr. 18, 2023

(30) Foreign Application Priority Data
Dec. 18, 2020 (GR) 20200100739

(51) Int. Cl. H04W 72/40; H04L 5/00; H04W 16/14; H04W 72/0453

(52) U.S. Cl. CPC H04W 72/40; H04L 5/001; H04W 16/14; H04W 72/0453

(57) ABSTRACT

Methods, systems, and devices for wireless communication are described to support selection of an unoccupied sidelink resource associated with a higher communication quality in a shared spectrum. User equipments (UEs) operating in shared spectrum may be configured with a set of candidate carriers for sidelink communications using the shared spectrum. A transmitting UE may select a number of resources for a sidelink transmission that are available in a same transmission time occasion and on multiple carriers of the set of carriers. The UE may perform a channel access procedure for each carrier of the multiple carriers prior to the transmission time occasion and may transmit a sidelink communication on at least one selected resource if the channel access procedure succeeds in at least one of the carriers of the multiple carriers.

### CROSS REFERENCE

The present Application is a 371 national stage filing of International PCT Application No. PCT/US2021/062605 by Wu et al. entitled “SIDELINK RESOURCE SELECTION IN UNLICENSED SPECTRUM,” filed Dec. 9, 2021; and claims priority to Greece Patent Application No. 20200100739 by Wu et al., entitled “SIDELINK RESOURCE SELECTION IN UNLICENSED SPECTRUM,” filed Dec. 18, 2020, each of which is assigned to the assignee hereof, and each of which is expressly incorporated by reference in its entirety herein.

### INTRODUCTION

The following relates to wireless communication, and more specifically to managing sidelink resources.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

A method for wireless communication at a UE is described. The method may include determining a resource selection configuration that indicates a set of multiple component carriers (CCs) for sidelink communications within a shared radio frequency spectrum band. The method may further include selecting a transmission time occasion that has a frequency resource available on multiple CCs of the set of multiple CCs based on the resource selection configuration and performing, prior to the transmission time occasion, a channel access procedure on each of the multiple CCs to determine whether a respective frequency resource of each of the multiple CCs is available. The method may also include transmitting, during the transmission time occasion, a first sidelink message within a corresponding frequency resource of at least one of the multiple CCs within the shared radio frequency spectrum band based on the channel access procedure.

An apparatus for wireless communication at a UE is described. The apparatus may include a processor and memory coupled to the processor. The processor and memory may be configured to determine a resource selection configuration that indicates a set of multiple CCs for sidelink communications within a shared radio frequency spectrum band. The processor and memory may also be configured to select a transmission time occasion that has a frequency resource available on multiple CCs of the set of multiple CCs based on the resource selection configuration and perform, prior to the transmission time occasion, a channel access procedure on each of the multiple CCs to determine whether a respective frequency resource of each of the multiple CCs is available. The processor and memory may be further configured to transmit, during the transmission time occasion, a first sidelink message within a corresponding frequency resource of at least one of the multiple CCs within the shared radio frequency spectrum band based on the channel access procedure.

Another apparatus for wireless communication at a UE is described. The apparatus may include means for determining a resource selection configuration that indicates a set of multiple CCs for sidelink communications within a shared radio frequency spectrum band. The apparatus may also include means for selecting a transmission time occasion that has a frequency resource available on multiple CCs of the set of multiple CCs based on the resource selection configuration and means for performing, prior to the transmission time occasion, a channel access procedure on each of the multiple CCs to determine whether a respective frequency resource of each of the multiple CCs is available. The apparatus may further include means for transmitting, during the transmission time occasion, a first sidelink message within a corresponding frequency resource of at least one of the multiple CCs within the shared radio frequency spectrum band based on the channel access procedure.

A non-transitory computer-readable medium storing code for wireless communication at a UE is described. The code may include instructions executable by a processor to determine a resource selection configuration that indicates a set of multiple CCs for sidelink communications within a shared radio frequency spectrum band. The code may further be executable by the processor to select a transmission time occasion that has a frequency resource available on multiple CCs of the set of multiple CCs based on the resource selection configuration and perform, prior to the transmission time occasion, a channel access procedure on each of the multiple CCs to determine whether a respective frequency resource of each of the multiple CCs is available. The code may also be executable by the processor to transmit, during the transmission time occasion, a first sidelink message within a corresponding frequency resource of at least one of the multiple CCs within the shared radio frequency spectrum band based on the channel access procedure.

Some examples of the method, apparatuses, and non-transitory computer-readable medium described herein may further include operations, features, means, or instructions for transmitting a resource reservation message indicating a resource allocation for two or more CCs of the multiple CCs.

Some examples of the method, apparatuses, and non-transitory computer-readable medium described herein may further include operations, features, means, or instructions for transmitting the resource reservation message indicating a corresponding carrier index of the two or more CCs and a respective frequency location for the resource allocation in each of the two or more CCs.

Some examples of the method, apparatuses, and non-transitory computer-readable medium described herein may further include operations, features, means, or instructions for transmitting the resource reservation message indicating a corresponding carrier index of the two or more CCs and a same frequency location for the resource allocation within a respective bandwidth of each of the two or more CCs.

Some examples of the method, apparatuses, and non-transitory computer-readable medium described herein may further include operations, features, means, or instructions for transmitting the resource reservation message indicating all of the set of multiple CCs and indicating a same frequency location within a respective bandwidth of each of the multiple CCs.

Some examples of the method, apparatuses, and non-transitory computer-readable medium described herein may further include operations, features, means, or instructions for transmitting the resource reservation message via the first sidelink message, the resource allocation indicating resources in the two or more CCs for a second sidelink message.

Some examples of the method, apparatuses, and non-transitory computer-readable medium described herein may further include operations, features, means, or instructions for transmitting the resource reservation message indicating the resource allocation that indicates a time location of the transmission time occasion in the two or more CCs.

Some examples of the method, apparatuses, and non-transitory computer-readable medium described herein may further include operations, features, means, or instructions for transmitting, during the transmission time occasion, the first sidelink message on two or more CCs of the multiple CCs within the shared radio frequency spectrum band.

Some examples of the method, apparatuses, and non-transitory computer-readable medium described herein may further include operations, features, means, or instructions for selecting the transmission time occasion that may have a frequency resource available on each CC of the set of multiple CCs based on the resource selection configuration.

Some examples of the method, apparatuses, and non-transitory computer-readable medium described herein may further include operations, features, means, or instructions for selecting the transmission time occasion that may have a frequency resource available at a same frequency location within a respective bandwidth of each CC of the multiple CCs based on the resource selection configuration.

In some examples of the method, apparatuses, and non-transitory computer-readable medium described herein, the multiple CCs include all of the set of multiple CCs.

Some examples of the method, apparatuses, and non-transitory computer-readable medium described herein may further include operations, features, means, or instructions for performing the channel access procedure that indicates the respective frequency resource of two or more CCs of the multiple CCs may be available.

Some examples of the method, apparatuses, and non-transitory computer-readable medium described herein may further include operations, features, means, or instructions for selecting a first CC of the two or more CCs for transmitting the first sidelink message based on the channel access procedure.

In some examples of the method, apparatuses, and non-transitory computer-readable medium described herein, the channel access procedure includes a listen before talk (LBT) procedure.

In some examples of the method, apparatuses, and non-transitory computer-readable medium described herein, the channel access procedure includes an energy detection procedure.

### BRIEF DESCRIPTION OF THE DRAWINGS

FIG. 1 illustrates an example of a wireless communications system that supports sidelink resource selection in unlicensed spectrum in accordance with one or more aspects of the present disclosure.

FIG. 2 illustrates an example of a resource selection scheme that supports sidelink resource selection in unlicensed spectrum in accordance with one or more aspects of the present disclosure.

FIG. 3 illustrates an example of a wireless communications system that supports sidelink resource selection in unlicensed spectrum in accordance with one or more aspects of the present disclosure.

FIG. 4 illustrates an example of a resource selection scheme that supports sidelink resource selection in unlicensed spectrum in accordance with one or more aspects of the present disclosure.

FIG. 5 illustrates an example of a resource selection configuration that supports sidelink resource selection in unlicensed spectrum in accordance with one or more aspects of the present disclosure.

FIG. 6 illustrates an example of a process flow that supports sidelink resource selection in unlicensed spectrum in accordance with one or more aspects of the present disclosure.

FIGS. 7 and 8 show block diagrams of devices that support sidelink resource selection in unlicensed spectrum in accordance with one or more aspects of the present disclosure.

FIG. 9 shows a block diagram of a communications manager that supports sidelink resource selection in unlicensed spectrum in accordance with one or more aspects of the present disclosure.

FIG. 10 shows a diagram of a system including a device that supports sidelink resource selection in unlicensed spectrum in accordance with one or more aspects of the present disclosure.

FIGS. 11 and 12 show flowcharts illustrating methods that support sidelink resource selection in unlicensed spectrum in accordance with one or more aspects of the present disclosure.

### DETAILED DESCRIPTION

Sidelink communications (e.g., communications over a sidelink channel, such as a physical shared sidelink channel (PSSCH)) in unlicensed or shared spectrum may operate in a distributed manner (e.g., using autonomous resource allocation by UEs, such as a mode 2 allocation). For example, a UE may monitor (e.g., and decode) sidelink communications (e.g., sidelink control information (SCI) and/or other transmissions) from other UEs that may indicate resources (e.g., time and frequency resources) reserved by the other UEs for sidelink communications within the unlicensed spectrum. In some cases, there may be multiple CCs (e.g., frequency bands within the unlicensed spectrum) available for sidelink communication within unlicensed spectrum (e.g., within a shared spectrum band). In such cases, a UE receiving on the sidelink may monitor multiple CCs or all CCs available for sidelink communication (e.g., to perform autonomous resource allocation and receive any sidelink communications intended for the UE).

A sidelink UE communicating in the unlicensed spectrum may also perform a channel access procedure before transmitting in a resource of the unlicensed spectrum. For example, the channel access procedure may include monitoring the resource prior to transmitting, and may indicate whether another radio access technology (RAT), such as Wi-Fi, is using the resource for wireless communications. Interference from other RATs in the unlicensed spectrum may limit an amount of resources available for resource selection by UEs (e.g., by occupying some of the resources otherwise available for resource selection), or may decrease overall communication quality within the unlicensed spectrum (e.g., via interference from the other RATs). The other RATs may also, in some cases, decrease a probability of a successful sidelink channel access (e.g., vehicle to everything (V2X) channel access) for transmission of a sidelink message (e.g., by using resources in the unlicensed spectrum for wireless communications).

In order to increase probability of selecting an unoccupied sidelink resource (e.g., a resource unused by another UE or another RAT) associated with a higher communication quality, UEs operating in unlicensed spectrum may be configured with a set of defined frequencies (e.g., a set of defined candidate CCs) for sidelink communications using the unlicensed spectrum (e.g., as defined by a wireless communications standard). A UE transmitting a sidelink message (e.g., sidelink communication or sidelink transmission to another UE) may select a number of resources in the unlicensed spectrum for transmission of a sidelink message. The number of resources may be available in a same transmission time occasion (e.g., a time duration or resource dimension for transmitting a sidelink message) and on different CCs of the set of CCs. The UE may, for example, select resources that are available on a subset (e.g., at least a portion) of CCs of the set of CCs (e.g., resources available on multiple CCs of the set of CCs), resources that are available on each CC of the set of CCs, or resources that are available at a same relative frequency location (e.g., a same subchannel index) on two or more CCs of the set of CCs. The UE may select the resources according to a resource selection configuration (e.g., defined by a wireless communications standard), which may specify a selection method or technique for selecting resources across the multiple CCs.

The UE may perform a channel access procedure (e.g., an LBT procedure or sidelink signal detection) for each CC of the subset of CCs prior to the transmission time occasion (e.g., that includes the selected resources) and may transmit a sidelink message on at least one selected resource if the channel access procedure succeeds in at least one of the CCs of the subset of CCs (e.g., one or more CCs associated with the at least one resource). The UE may, for example, transmit the sidelink message using a selected resource on one CC of the subset of CCs that passes the channel access procedure or using a respective selected resource on multiple CCs that each pass the channel access procedure (e.g., all CCs that pass the channel access procedure). In some cases, the transmitting UE may also select resources across multiple CCs for a future sidelink transmission (e.g., may reserve selected future resources) by transmitting control information (e.g., SCI) indicating a reservation of the selected future resources. The UE may also perform a channel access procedure for each CC reserving future resources, for example, prior to transmitting on the reserved resources.

The described techniques may increase a probability of a successful channel access procedure for sidelink communication in unlicensed spectrum, which may increase a capacity of the sidelink communications, the unlicensed spectrum, or both. For example, it may be less likely that the channel access procedure may fail in all of the CCs that include selected resources, in comparison to failing in just one CC of the set of CCs. The described techniques may also increase a probability of successfully decoding the transmitted sidelink message. For example, selecting resources on multiple CCs for the sidelink message may increase communication diversity at a receiving UE (e.g., at each receiving UE). The described techniques may also increase utilization of resources within unlicensed spectrum (e.g., or other multi-carrier spectrum), for example, based on the increased probability of successful channel access, which may increase a spectral efficiency of the wireless network. Such techniques, individually or collectively, may also increase a data throughput (e.g., data rate) at a UE (e.g., a UE performing sidelink communications).

Aspects of the disclosure are initially described in the context of wireless communications systems. Aspects of the disclosure are further illustrated by and described with reference to resource selection schemes, a resource selection configuration, a process flow, apparatus diagrams, system diagrams, and flowcharts that relate to sidelink resource selection in unlicensed spectrum.

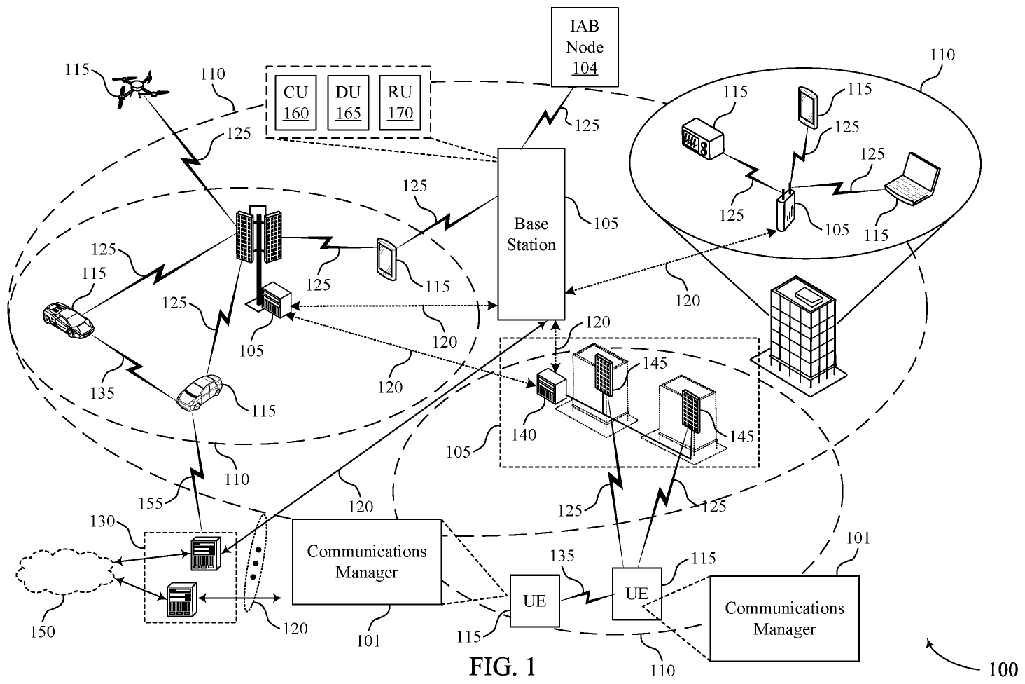

FIG. 1 illustrates an example of a wireless communications system 100 that supports sidelink resource selection in unlicensed spectrum in accordance with one or more aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links. A UE 115 may communicate with the core network 130 through a communication link 155.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). In some cases, a communication link 135 may be referred to as a sidelink communication link and may be used for sidelink communications between UEs 115. One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using V2X communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example, in the range of 300 megahertz (MHz) to 300 gigahertz (GHz). The region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Techniques described herein, in addition to or as an alternative to be carried out between UEs 115 and base stations 105, may be implemented via additional or alternative wireless devices, including IAB nodes 104, distributed units (DUs) 165, centralized units (CUs) 160, radio units (RUs) 170, and the like. For example, in some implementations, aspects described herein may be implemented in the context of a disaggregated radio access network (RAN) architecture (e.g., open RAN architecture). In a disaggregated architecture, the RAN may be split into three areas of functionality corresponding to the CU 160, the DU 165, and the RU 170. The split of functionality between the CU 160, DU 165, and RU 175 is flexible and as such gives rise to numerous permutations of different functionalities depending upon which functions (e.g., medium access control (MAC) functions, baseband functions, radio frequency functions, and any combinations thereof) are performed at the CU 160, DU 165, and RU 175. For example, a functional split of the protocol stack may be employed between a DU 165 and an RU 170 such that the DU 165 may support one or more layers of the protocol stack and the RU 170 may support one or more different layers of the protocol stack.

Some wireless communications systems (e.g., wireless communications system 100), infrastructure and spectral resources for NR access may additionally support wireless backhaul link capabilities in supplement to wireline backhaul connections, providing an IAB network architecture. One or more base stations 105 may include CUs 160, DUs 165, and RUs 170 and may be referred to as donor base stations 105 or IAB donors. One or more DUs 165 (e.g., and/or RUs 170) associated with a donor base station 105 may be partially controlled by CUs 160 associated with the donor base station 105. The one or more donor base stations 105 (e.g., IAB donors) may be in communication with one or more additional base stations 105 (e.g., IAB nodes 104) via supported access and backhaul links. IAB nodes 104 may support mobile terminal (MT) functionality controlled and/or scheduled by DUs 165 of a coupled IAB donor. In addition, the IAB nodes 104 may include DUs 165 that support communication links with additional entities (e.g., IAB nodes 104, UEs 115, etc.) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In some examples, the wireless communications system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of base stations 105. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the core network 130 and the AN (e.g., via a wireline or wireless connection to the core network 130). That is, an IAB donor may refer to a RAN node with a wireline or wireless connection to core network 130. The IAB donor may include a CU 160 and at least one DU 165 (e.g., and RU 170), where the CU 160 may communicate with the core network 130 over an NG interface (e.g., some backhaul link). The CU 160 may host layer 3 (L3) (e.g., RRC, service data adaption protocol (SDAP), PDCP, etc.) functionality and signaling. The at least one DU 165 and/or RU 170 may host lower layer, such as layer 1 (L1) and layer 2 (L2) (e.g., RLC, MAC, physical (PHY), etc.) functionality and signaling, and may each be at least partially controlled by the CU 160. The DU 165 may support one or multiple different cells. IAB donor and IAB nodes 104 may communicate over an F1 interface according to some protocol that defines signaling messages (e.g., F1 AP protocol). Additionally, CU 160 may communicate with the core network over an NG interface (which may be an example of a portion of backhaul link), and may communicate with other CUs 160 (e.g., a CU 160 associated with an alternative IAB donor) over an Xn-C interface (which may be an example of a portion of a backhaul link).

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 160 with a wireline (e.g., optical fiber) or wireless connection to the core network and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more IAB nodes 104 or components of IAB nodes 104) may be configured to support techniques for large round trip times in random access channel procedures as described herein. For example, some operations described as being performed by a UE 115 or a base station 105 may additionally or alternatively be performed by components of the disaggregated RAN architecture (e.g., IAB nodes, DUs, CUs, etc.).

In various examples, a communication manager 101 may be included in a UE 115 to support sidelink resource management (e.g., resource identification and selection). In some examples, a communication manager 101 may determine a resource selection configuration that indicates a set of CCs for sidelink communications within a shared radio frequency spectrum band (e.g., an unlicensed band). The communication manager 101 may further select a transmission time occasion that has a frequency resource available on multiple CCs of the set of CCs based on the resource selection configuration and may perform, prior to the transmission time occasion, a channel access procedure on each of the multiple CCs to determine whether a respective frequency resource of each of the multiple component carriers is available. The communication manager may also transmit, during the transmission time occasion, a first sidelink message within a corresponding frequency resource of at least one of the multiple CCs within the shared radio frequency spectrum band based on the channel access procedure.

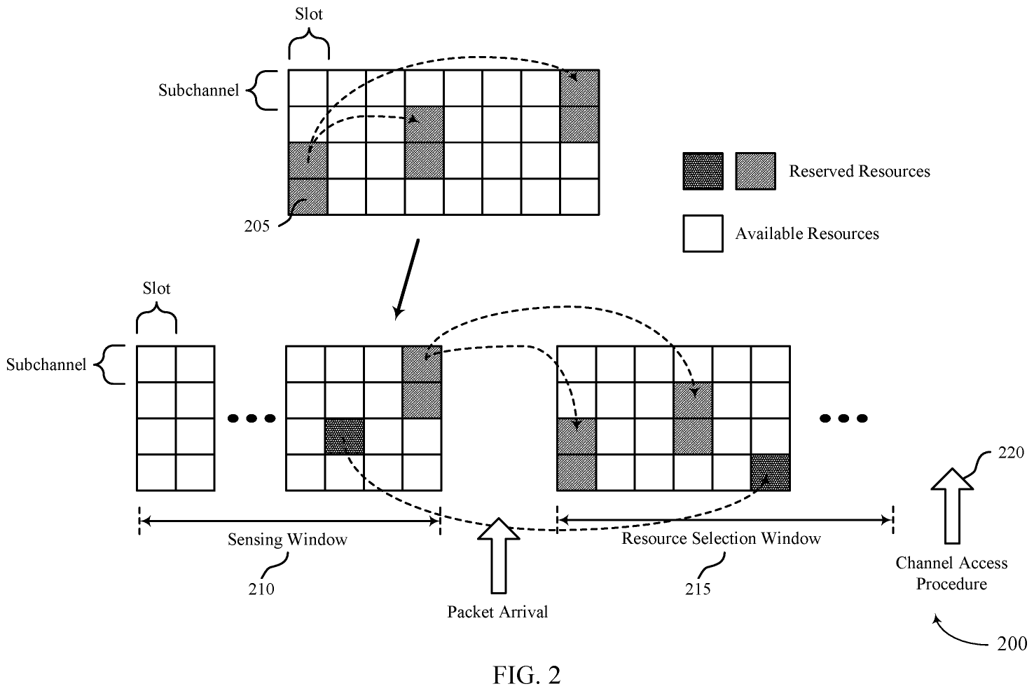

FIG. 2 illustrates an example of a resource selection scheme 200 that supports sidelink resource selection in accordance with one or more aspects of the present disclosure. In some examples, resource selection scheme 200 may represent a selection scheme used by a first UE 115 to select sidelink resources for transmitting a sidelink message using unlicensed or shared spectrum. The first UE 115 may communicate with one or more second UEs 115 over a sidelink channel (e.g., in the unlicensed or shared spectrum). The first UE 115 and the one or more second UEs 115 described herein may each represent an example of a UE 115 described with reference to FIG. 1.

Some sidelink communications (e.g., V2X communications) may be designed to target deployment in a licensed spectrum (e.g., a licensed spectrum band), where the sidelink communications may either share the licensed spectrum in a licensed cellular band or may use a dedicated intelligent transportation system (ITS) spectrum. In a licensed cellular spectrum, the sidelink communications (e.g., V2X) may share an uplink spectrum in a cellular network, while a dedicated ITS spectrum may represent one or more spectrums around a frequency range (e.g., around 5.9 GHz) that may be allocated for sidelink communications (e.g., V2X), in some regions or countries.

In some cases, a dedicated spectrum for sidelink communications (e.g., V2X) may be scarce or unavailable (e.g., may not be guaranteed) in some regions, for example, based on a scarcity of spectrum. For example, in some areas or countries, there may be a dedicated spectrum allocated for first sidelink communications (e.g., LTE V2X), but limited spectrum (e.g., some or no spectrum) may be available for second sidelink communications (e.g., NR V2X, which may target V2X usage cases such as autonomous driving).

As such, some cellular sidelink communications (e.g., some cellular V2X communications) may be deployed in unlicensed spectrum, for example, based on being an only feasible option in some regions. Unlicensed spectrum may be shared with other communications technologies, such as Wi-Fi, and in some cases may be referred to as shared spectrum or a shared radio frequency spectrum band. A range of unlicensed spectrums may be available for sidelink communications, for example, from 5 GHz to 6 GHz. For example, unlicensed national information infrastructure (U-NII) bands may be available, such as U-NII-3 spectrum (e.g., from 5.725 GHz to 5.850 GHz) or U-NII-4 spectrum (e.g., from 5.850 GHz to 5.925 GHz), or spectrum at or above 6 GHz may be available.

In unlicensed spectrum, a minimum channel bandwidth may be specified, for example, following regional regulations (e.g., some regions may have a minimum channel bandwidth of 5 MHz). A device (e.g., a device using any technology) may transmit in a bandwidth (e.g., a minimum channel bandwidth) within unlicensed spectrum. For example, a device may transmit with a channel bandwidth of 20 MHz, 80 MHz, or 160 MHz, among other examples.

Some sidelink communications (e.g., NR V2X) may support autonomous resource allocation by UEs 115 (e.g., a mode 2 resource allocation). In such cases, a UE 115 (e.g., the first UE 115) may access a channel based on sensing outcomes. For example, the first UE 115 may identify available resources for a sidelink transmission (e.g., sidelink message), which may be referred to as candidate resources. The first UE 115 may select one or more resources 205 for the sidelink transmission from the candidate resources. A UE 115 may also reserve a number of future resources (e.g., in addition to the resource(s) 205) for the sidelink transmission, for example, for retransmission of a packet of the sidelink transmission. One or more first resources 205 for the sidelink transmission may identify or reserve the number of future resources for retransmission of the sidelink transmission (e.g., as indicated by the arrows in FIG. 2).

To identify available resources, the first UE 115 may monitor and decode some or all transmissions (e.g., SCI) from the one or more second UEs 115 and may perform a reference signal received power (RSRP) measurement for each of the decoded transmissions. When resource selection is triggered at the first UE 115 (e.g., a packet arrives for transmission from the first UE 115), the first UE 115 may determine a sensing window 210 (e.g., a window in the past) and may determine available resources based on SCI decoding and/or RSRP measurement in the sensing window 210. The first UE 115 may identify available resources in a resource selection window 215 (e.g., a window in the future) by projecting decoding and/or measurement outcomes from the sensing window to the resource selection window 215. For example, a resource in the resource selection window 215 may be considered available if the SCI (e.g., the SCI decoding outcomes) indicate no reservation of the resource in the resource selection window 215 or if the resource has been reserved but a measured RSRP projected to the resource is below an RSRP threshold. To select a resource for transmission, the first UE 115 may perform random resource selection from the available resources.

Accordingly, to perform autonomous resource allocation (e.g., mode 2 allocation), the first UE 115 may monitor sidelink transmissions and perform RSRP measurements and may perform resource selection when such selection is triggered (e.g., resource selection may be triggered by a packet arrival).

A channel access procedure 220 may be performed before transmitting using unlicensed spectrum (e.g., NR unlicensed (NR-U)) and may, for example, include channel access types such as a type 1 channel access or a type 2 channel access. A type 1 channel access may, for example, include a random time duration spanned by sensing slots that are sensed by a UE 115 (e.g., the first UE 115) to be idle before one or more sidelink transmissions (e.g., which may be referred to as a category 4 (CAT 4) listen before talk (LBT) procedure). A type 2 channel access may include a deterministic time duration spanned by sensing slots that are sensed by a UE 115 (e.g., the first UE 115) to be idle before one or more sidelink transmissions. For example, a type 2A channel access may have a sensing duration of 25 microseconds (μs), a type 2B channel access may have a sensing duration of 16 μs, and a type 2C channel accessing may perform no sensing (e.g., which may be applied when a gap is no larger than 16 μs).

In some cases in NR-U, a base station 105 may initiate a channel occupancy (e.g., a channel occupancy time (COT)), for example, based on type 1 channel access. In some cases, a UE 115 (e.g., the first UE 115) may share the channel occupancy, where the UE 115 may perform type 2 channel access before one or more intended transmissions. In such cases, the UE 115 may transmit if the type 2 channel access is successful. For sidelink communications in unlicensed spectrum, a UE 115 may initiate a channel occupancy, for example, based on a type 1 channel access, where another UE 115 may share the channel occupancy (e.g., may transmit in the channel occupancy based on a type 2 channel access).

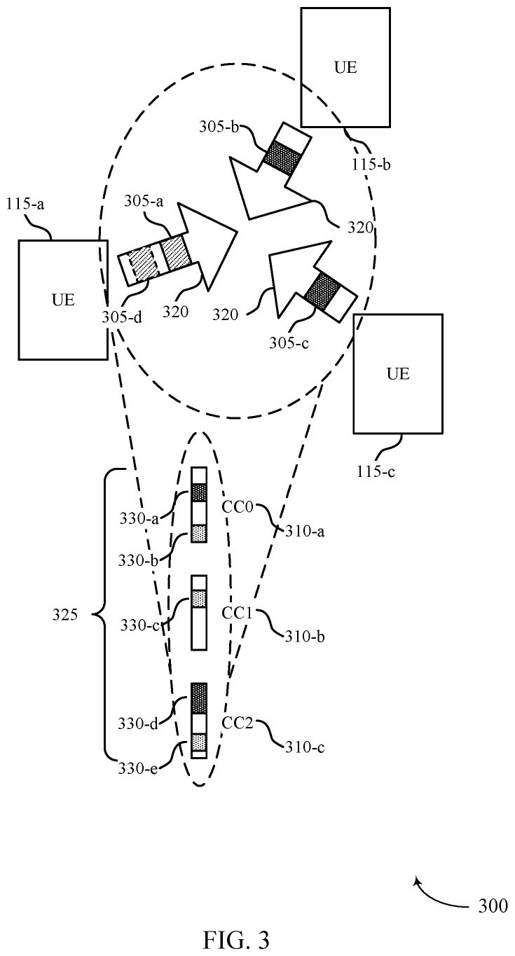

FIG. 3 illustrates an example of a wireless communications system 300 that supports sidelink resource selection in unlicensed spectrum in accordance with one or more aspects of the present disclosure. Wireless communications system 300 may implement or be implemented by aspects of wireless communications system 100 and/or resource selection scheme 200. Wireless communications system 300 may include UEs 115-a, 115-b, and 115-c (e.g., among other UEs 115), which may each represent an example of a UE 115 described with reference to FIGS. 1 and 2. UEs 115-a, 115-b, and 115-c may communicate with each other or with one or more other UEs 115 in unlicensed spectrum (e.g., shared spectrum) via sidelink communications 320 (e.g., V2X communications).

Sidelink communications 320 (e.g., cellular V2X) over a sidelink channel in unlicensed spectrum may operate in a distributed manner (e.g., using autonomous resource allocation, such as mode 2 allocation). For example, UEs 115-a, 115-b, and 115-c may communicate on their own, without any central nodes (e.g., base stations 105) scheduling or assisting with the sidelink communications 320. For such sidelink communications, a UE 115 may monitor (e.g., and decode) sidelink communications 320 (e.g., SCI and/or other transmissions) from other UEs 115. For example, UE 115-a may monitor for sidelink messages 305-b and 305-c from UEs 115-b and 115-c, respectively (e.g., among other sidelink communications 320). The UE 115 may monitor sidelink communications 320 when the UE 115 does not transmit, for example, such that the UE 115 may not miss sidelink messages 305 from other UEs 115 (e.g., vehicles or pedestrians).

In some cases, there may be multiple carriers (e.g., CCs 310) available for sidelink communication within unlicensed spectrum (e.g., within a shared radio frequency spectrum band 325). In such cases, a UE 115 receiving on the sidelink may monitor multiple CCs 310 or all CCs 310 available for the sidelink communication (e.g., V2X communication). A UE 115 transmitting on the sidelink may determine or select a CC for transmitting a sidelink message 305 (e.g., a sidelink transmission or a sidelink message).

In some cases, interference from other RATs (e.g., Wi-Fi) may be relatively large for sidelink communications 320 in unlicensed spectrum. A sidelink signal range (e.g., V2X range) may be a larger range than signaling from the other RATs (e.g., may have a range of hundreds of meters), but the sidelink signal strength may decrease the farther the sidelink signal travels. In some cases, a receiving UE 115 (e.g., UE 115-b) may be relatively farther away from a transmitting UE 115 (e.g., UE 115-a). In such cases, the transmitting UE 115 may identify a clear channel (e.g., using a channel access procedure) but the receiving UE 115 may see or experience different channel conditions (e.g., higher interference from another, closer RAT, known as local interference) based on the location of the receiving UE 115.

Additionally, different UEs 115 may experience different communication quality (e.g., interference) on different CCs 310. For example, UE 115-b may experience higher interference in a first CC 310-a (e.g., CC0), while UE 115-c may experience higher interference in a second CC 310-b (e.g., CC1). In some cases, a transmitting UE 115 may transmit a sidelink message 305 to multiple receiving UEs 115 in a selected CC 310 (e.g., sidelink broadcast or groupcast), where the receiving UEs 115 may experience different interference levels in the selected CC 310. For example, UE 115-a may transmit sidelink message 305-a via CC0 to UEs 115-b and 115-c (e.g., among other UEs 115), where UE 115-b may experience a higher interference level in CC0 than an interference level experienced by UE 115-c, which may result in a lower communication quality for sidelink message 305-a for UE 115-b. In some cases, UE 115-a may also transmit a second sidelink message 305-d, where sidelink message 305-a may indicate resources for sidelink message 305-d.

The interference from other RATs in the unlicensed spectrum may limit an amount of resources available for resource selection by UEs 115-a, 115-b, and 115-c, or may decrease overall communication quality within the unlicensed spectrum (e.g., via additional interference from the other RATs). The other RATs may also, in some cases, decrease a probability of a successful sidelink channel access (e.g., V2X channel access) for transmission of a sidelink message 305.

In order to increase probability of selecting an unoccupied sidelink resource associated with a higher communication quality, UEs 115 operating in unlicensed spectrum may be configured with a set of defined frequencies (e.g., a set of defined candidate CCs 310) for sidelink communications (e.g., V2X) using the unlicensed spectrum (e.g., as defined by a wireless communications standard). The set of frequencies may be channelized to a number of CCs (e.g., the set of candidate CCs), and each CC 310 may have a defined bandwidth (e.g., 20 MHz).

A transmitting UE 115 (e.g., UE 115-a) may select a number of resources for a sidelink transmission that are available in a same transmission time occasion (e.g., slot) and on different CCs 310 of the set of CCs. UE 115-a may, for example, select resources that are available on all or a subset of CCs 310 of the set of CCs (e.g., multiple CCs of the set of CCs), resources that are available on each CC 310 of the set of CCs, or resources that are available at a same relative frequency location 330 (e.g., a same subchannel index) on two or more CCs 310 of the set of CCs. The transmitting UE 115 may select the resources according to a resource selection configuration (e.g., defined by a wireless communications standard).

The transmitting UE 115 may perform a channel access procedure (e.g., an LBT procedure or sidelink signal detection) for each CC 310 of the subset of CCs prior to the transmission time occasion and may transmit a sidelink message 305 (e.g., sidelink message 305-a) on at least one selected resource if the channel access procedure succeeds in at least one of the CCs 310 of the subset of CCs. The transmitting UE 115 may, for example, transmit the sidelink message 305 using a selected resource on one CC 310 of the subset of CCs that passes the channel access procedure or using a respective selected resource on multiple CCs 310 that pass the channel access procedure (e.g., all CCs that pass the channel access procedure). In some cases, the transmitting UE 115 (e.g., UE 115-a) may also select resources for a future sidelink transmission (e.g., may reserve the selected resources), for example, by transmitting control information reserving the selected resources across the multiple CCs 310.

The described techniques may increase probability of a successful channel access procedure for sidelink communication in unlicensed spectrum. For example, it is less likely that the channel access procedure would fail in all of the CCs 310 that include selected resources, in comparison to failing in just one CC 310 of the set of CCs. The described techniques may also increase probability of successful decoding of the transmitted sidelink message 305 (e.g., sidelink message 305-a). For example, selecting resources on multiple CCs 310 for the sidelink communication may increase communication diversity at a receiving UE 115 (e.g., at each receiving UE 115), for example, based on a location of the receiving UE 115 (e.g., when a transmitting UE 115 transmits a same sidelink message or transport block (TB) on multiple CCs 310). The described techniques may also increase utilization of resources within unlicensed spectrum (e.g., or other multi-carrier spectrum), for example, based on the increased probability of successful channel access.

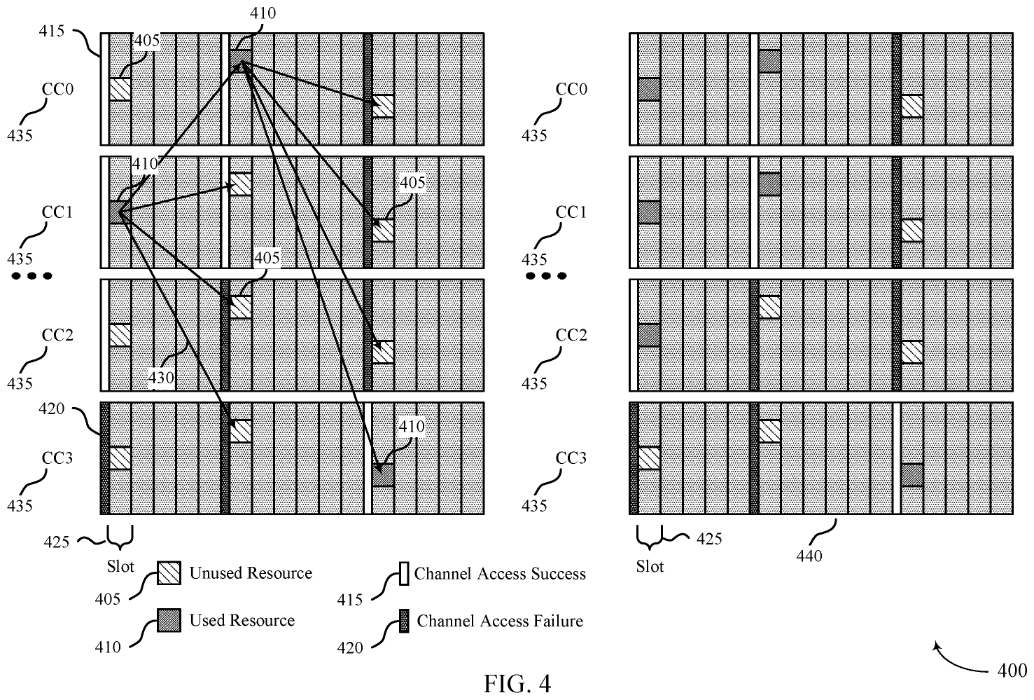

FIG. 4 illustrates an example of a resource selection scheme 400 that supports sidelink resource selection in unlicensed spectrum in accordance with one or more aspects of the present disclosure. Resource selection scheme 400 may implement or be implemented by aspects of wireless communications system 100 or 300. Some aspects of resource selection scheme 400 may implement or be implemented by aspects of resource selection scheme 200. A first UE 115 may use one or more aspects of resource selection scheme 400 to select resources for one or more sidelink messages (e.g., one or more sidelink communications as described with reference to FIG. 3), where the first UE 115 may represent an example of a UE 115 described with reference to FIGS. 1-3.

As described with reference to FIG. 3, the first UE 115 may select a number of resources 405 and 410 (e.g., frequency resources) for a sidelink message (e.g., a TB), where the resources may be available in a same transmission time occasion 425 (e.g., slot) on multiple CCs of a set of candidate CCs defined for sidelink communication in unlicensed spectrum (e.g., by a wireless communications standard). For example, when performing resource selection, the first UE 115 may select resources in a transmission time occasion 425 in which all or multiple CCs of the set of candidate CCs have resource(s) available. The first UE 115 may perform a channel access procedure (e.g., an LBT procedure or sidelink signal detection) for each CC in which resources are selected prior to the transmission time occasion 425. The first UE 115 may transmit a sidelink message on at least one selected resource if the channel access procedure succeeds in at least one of the CCs of the subset of CCs.

The channel access procedure may include one or multiple channel access procedures. For example, the channel access procedure may include a type 1 channel access (e.g., CAT 4 LBT), a type 2A channel access (e.g., a category 2 (CAT 2) LBT), a type 2B channel access (e.g., a CAT 2 LBT), or any combination thereof. The type 1 channel access may include an energy detection based channel sensing by the first UE 115, with a random backoff in a contention window. The type 2A or type 2B channel access may include an energy detection based channel sensing without a random backoff (e.g., sensing in a sensing window having a fixed duration). The energy detection based channel sensing of a type 1 or a type 2 channel access may include determining if energy measured in the sensing window (e.g., sensing slot) is less than an energy detection threshold. For example, for type 2A or type 2B channel access, if the energy measured is less than the threshold, the channel access procedure may be considered successful or passed. If the energy measured is greater than the threshold, the channel access procedure may be considered failed.

Additionally or alternatively, the channel access procedure may be based on sidelink signal detection, or sensing (e.g., V2X sensing). The signal detection may include SCI decoding or sidelink channel occupancy detection (e.g., V2X channel occupancy detection), among other examples. For example, the first UE 115 may select a resource in a CC and a slot (e.g., slot n). The first UE 115 may perform sidelink signal detection in the CC, and if the first UE 115 detects a sidelink channel occupancy (e.g., V2X channel occupancy) that includes the slot (e.g., slot n) the first UE 115 may assume a successful channel access (e.g., a channel access success 415) in the CC in the slot. The first UE 115 may therefore transmit its sidelink message in the selected resource in the slot (e.g., slot n). The first UE 115 may detect the sidelink channel occupancy, for example, by decoding a sidelink message (e.g., sidelink transmission) in the previous slot (e.g., slot n−1), which may indicate that the slot (e.g., slot n) is included in the sidelink channel occupancy.

In some cases, the first UE 115 may also perform a type 2A or type 2B channel access prior to transmitting in the slot (e.g., slot n), when the slot is included in a sidelink channel occupancy. In such cases, the first UE 115 may transmit in the slot if the type 2A or type 2B channel access is successful. In some other cases, the first UE 115 may perform a type 1 channel access prior to transmitting in the slot (e.g., slot n).

As described herein, the first UE 115 may select resources 405 and 410 in multiple CCs (e.g., in N CCs, where N>1). In some cases, the first UE 115 may determine a successful channel access in two or more CCs (e.g., M CCs, where 1<M≤N). In a first example, the first UE 115 may transmit the sidelink message in one of the carriers for which the first UE 115 determined a channel access success 415 (e.g., one of the M carriers). For example, the first UE 115 may transmit the sidelink message in a selected resource 410 of a CC having a lowest energy detection or interference, or using a randomly selected CC (e.g., from the two or more CCs having a successful channel access).

In a second example, the first UE 115 may transmit the sidelink message using more than one of the two or more CCs (e.g., more than one of the M CCs). For example, the first UE 115 may transmit the sidelink message using a respective resource 410 in each of the two or more CCs (e.g., in each CC that returned a successful channel access, or all of the M CCs). The transmission of the sidelink message in more than one of the M CCs may be for a same packet or TB (e.g., may represent a repetition of the TB in multiple CCs).

For example, as illustrated by FIG. 4, a channel access success 415 may result in CC0, CC1, and CC2 for selecting resources in a first transmission time occasion 425 (e.g., and a channel access failure 420 may result in CC3). In the first example, the first UE 115 may transmit the sidelink message in one of the CCs having a channel access success 415 (e.g., CC1). In the second example, the first UE 115 may transmit the sidelink message in multiple CCs having a channel access success 415 (e.g., in CC0, CC1, and CC2). In either example, the first UE 115 may refrain from transmitting the sidelink message in any CC that resulted in a channel access failure 420, or in an unselected CC (e.g., the respective selected resource 405 in the CC may go unused).

The first UE 115 may additionally or alternatively select resources 405 and 410 in multiple transmission occasions (e.g., slots). The selected resources in each transmission occasion may be within the same occasion (e.g., slot) but in different CCs. The first UE 115 may reserve future resources when transmitting in a preceding transmission time occasion 425 (e.g., slot), for example, by indicating the resource reservation(s) in a future transmission time occasion 425 (e.g., by transmitting a resource reservation message 430 indicating an allocation of resources 405 and 410). For example, the first UE 115 may include, in a first sidelink message, an indication of resources reserved across multiple CCs in a future (e.g., sixth) transmission time occasion 425 or in multiple future (e.g., sixth and twelfth) transmission time occasions 425. Similarly, the first UE 115 may include, in a second sidelink message, an indication of resources reserved in one or more future transmission time occasions (e.g., twelfth occasion).

The selected resources in the future transmission time occasion(s) 425 in the multiple CCs may be indicated as a reserved resource, and may be treated as such by one or more second UEs 115 (e.g., that receive the resource reservation indication from the first UE 115). The first UE 115 may perform a channel access procedure prior to each transmission time occasion 425 having reserved resources (e.g., prior to the sixth and twelfth slots), and may transmit a sidelink message in the respective transmission time occasion 425 based on the results of the channel access procedure (e.g., may use one or more CCs that passed the channel access procedure).

In a first example, the first UE 115 may select resources for multiple (e.g., three) transmission time occasions 425. In the first transmission time occasion 425, the first UE 115 may succeed with a channel access in CC1 (e.g., among other CCs) and may transmit a first sidelink message in CC1. The first sidelink message in CC1 may indicate the reserved resources in the next selected transmission time occasion 425. The first UE 115 may perform a channel access procedure prior to the next selected transmission time occasion 425 and may transmit a second sidelink message in a carrier that has a successful channel access (e.g., CC0). The second sidelink message may indicate the reserved resources in the next selected transmission time occasion 425. The first UE 115 may perform a channel access procedure prior to the next selected transmission time occasion 425 and may transmit a third sidelink message in a carrier that has a successful channel access (e.g., CC3).

In a second example, the first UE 115 may select resources for multiple (e.g., three) transmission time occasions 425. In the first transmission time occasion 425, the first UE 115 may succeed with a channel access in CC0, CC1, and CC2 and may transmit a first sidelink message in CC0, CC1, and CC2. The first sidelink message may indicate the reserved resources in the next selected transmission time occasion 425. The first UE 115 may perform a channel access procedure prior to the next selected transmission time occasion 425 and may transmit a second sidelink message in one or more CCs that have a successful channel access (e.g., CC0 and CC1). The second sidelink message may indicate the reserved resources in the next selected transmission time occasion 425. The first UE 115 may perform a channel access procedure prior to the next selected transmission time occasion 425 and may transmit a third sidelink message in a one or more carriers that have a successful channel access (e.g., CC3).

When indicating reserved resources, the first UE 115 may indicate a time location 440 (e.g., transmission time occasion 425) of the reserved resources. For example, the first UE 115 may indicate a slot interval (e.g., slot index) to one or more future transmission time occasions 425. Additionally or alternatively, the first UE 115 may indicate an index of the transmission time occasion 425 of the reserved resources, such as a slot index. The first UE 115 may also indicate a frequency location of the reserved resources. For example, the first UE 115 may indicate a frequency allocation or index for the frequency location, where the frequency allocation or index may indicate a number of subcarriers or subchannels, a number of resource elements, a number of resource blocks, a BWP, a frequency band, a frequency subchannel, or any combination thereof (e.g., among other examples). The first UE 115 may indicate the reserved resources to one or more second UEs 115 via SCI. In some cases, the SCI may be transmitted or broadcast in a standalone message (e.g., standalone control message) to the one or more second UEs 115, for example, to notify the one or more second UEs 115 of the resource reservation.

In a first example, the first UE 115 may indicate a frequency location of a respective resource in each CC, along with a corresponding carrier index 435 (e.g., where the reserved resources in different CCs may have different frequency locations). A carrier index 435 may represent an index of a corresponding CC, for example, within the set of CCs. For example, a first CC of the set of CCs may have an index of 0, a second CC of the set of CCs may have an index of 1, and so on for each of the CCs of the set of CCs.

In a second example, the first UE 115 may indicate a frequency location of the reserved resources in one CC (e.g., of the candidate CCs), and may indicate a corresponding carrier index 435 for each CC that includes the reserved resources. In such cases, the frequency locations of the reserved resources may be in a same relative location (e.g., same subchannel index) within the different CCs. In some cases, the first UE 115 may indicate CCs having the reserved resources using a bit map. For example, a value of ‘1101’ for the bitmap may indicate resource reservation in CC0, CC1, and CC3 (e.g., of the candidate CCs).

In a third example, the first UE 115 may indicate a frequency location (e.g., subchannel index) of the reserved resources in one CC (e.g., of the candidate CCs). The reserved resources may have a same frequency location in all of the candidate CCs in the indicated transmission time occasion 425, and any receiving UE 115 may implicitly determine that the indicated frequency location is reserved in each of the candidate CCs in the indicated transmission time occasion 425.

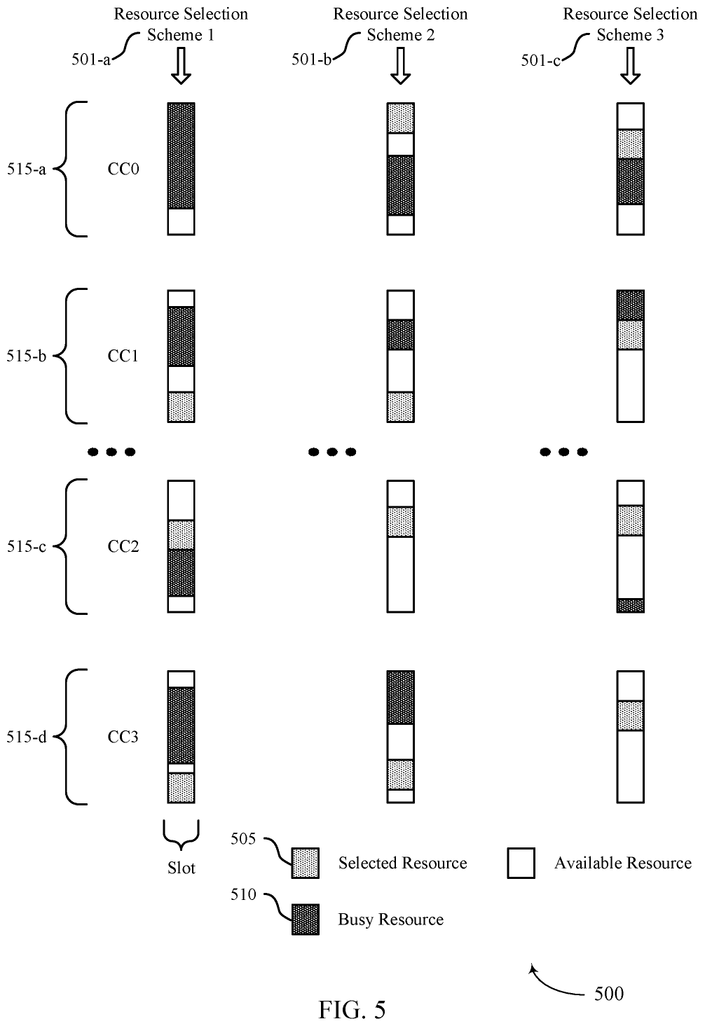

FIG. 5 illustrates an example of a resource selection configuration 500 that supports sidelink resource selection in unlicensed spectrum in accordance with one or more aspects of the present disclosure. Resource selection configuration 500 may implement or be implemented by aspects of wireless communications system 100 or 300. Some aspects of resource selection configuration 500 may implement or be implemented by aspects of resource selection scheme 200. A first UE 115 may use one or more aspects of resource selection configuration 500 to select resources for one or more sidelink messages (e.g., one or more sidelink communications as described with reference to FIG. 3), where the first UE 115 may represent an example of a UE 115 described with reference to FIGS. 1-4.

As described with reference to FIG. 3, the first UE 115 may select a number of resources 505 for a sidelink message, where the resources may be available in a same transmission time occasion (e.g., slot) on multiple CCs of a set of candidate CCs defined for sidelink communication in unlicensed spectrum (e.g., by a wireless communications standard). The first UE 115 may use information received from one or more second UEs 115 (e.g., via SCI) to select the resources 505, which information may indicate reserved or busy resources 510 within the set of CCs (e.g., resources that are not available for selection). Resource selection configuration 500 may specify one or more resource selection schemes 501 for selecting the resources 505 across the multiple CCs, for example, based on resource availability.

In a first resource selection scheme 501-a, the first UE 115 may select resources 505 in a transmission occasion that has frequency resources available in more than one CC of the set of CCs. For example, the first UE 115 may select resources 505 in a transmission time occasion if there are resources available in at least M CCs of the set of CCs (e.g., where M>1 and has a defined value, such as M=2) in that transmission time occasion as determined by performing a channel access procedure on the respective CCs. The resources 505 may be at different relative frequency locations in the at least two CCs and may or may not be available in each CC. For example, resources may be unavailable in CC0, but resources 505 may be available at different relative frequency locations in CC1, CC2, and CC3. In such cases, the first UE 115 may select the resources 505 and may perform a channel access procedure in the corresponding CCs before transmitting using one or more of the resources 505. In transmission time occasions where resources are available in only one CC of the set of CCs, the first UE 115 may refrain from selecting resources 505.

In a second resource selection scheme 501-b, the first UE 115 may select resources 505 in a transmission occasion that has frequency resources available in each CC the set of CCs (e.g., in all candidate CCs). For example, the first UE 115 may select resources 505 in a transmission time occasion if there are resources available in each CC (e.g., of the set of CCs) in that transmission time occasion. The resources 505 may be at different relative frequency locations in the CCs. For example, resources 505 may be available at different relative frequency locations in CC0, CC1, CC2, and CC3. In such cases, the first UE 115 may select the resources 505 and may perform a channel access procedure in the corresponding CCs before transmitting using one or more of the resources 505. In transmission time occasions where resources are unavailable in each CC of the set of CCs, the first UE 115 may refrain from selecting resources 505.

In a third resource selection scheme 501-c, the first UE 115 may select resources 505 in a transmission occasion that has frequency resources available in two or more CCs (e.g., or all) of the set of CCs at a same relative frequency location (e.g., same subchannel index) within a bandwidth 515 of the respective CC (e.g., at a same frequency offset within the bandwidth 515 of the respective CC). For example, the first UE 115 may select resources 505 in a transmission time occasion if there are resources available at a same relative frequency location in M CCs (e.g., or all CCs) of the set of CCs in that transmission time occasion (e.g., where M>1 and has a defined value, such as M=2). For example, resources 505 may be available at a same relative frequency location (e.g., same subchannel index) in each of CC0, CC1, CC2, and CC3. In such cases, the first UE 115 may select the resources 505 and may perform a channel access procedure in each of the corresponding CCs before transmitting using one or more of the resources 505. The third resource selection scheme 501-c may reduce signaling overhead for reserving the selected resources 505, for example, by signaling a single, relative frequency location that may be applicable to multiple CCs. In transmission time occasions where resources are unavailable at a same relative frequency location in at least two CCs of the set of CCs, the first UE 115 may refrain from selecting resources 505.

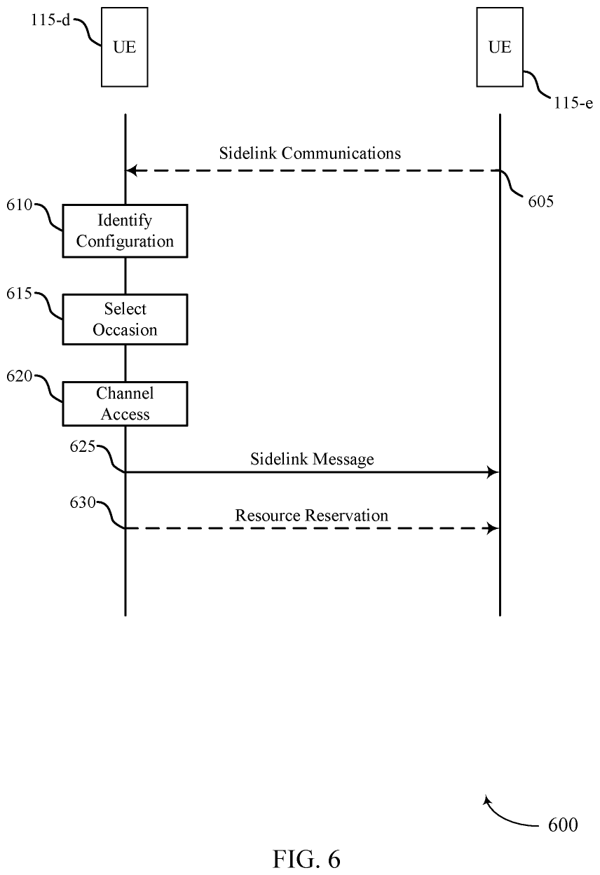

FIG. 6 illustrates an example of a process flow 600 that supports sidelink resource selection in unlicensed spectrum in accordance with one or more aspects of the present disclosure. In some examples, process flow 600 may implement or be implemented by aspects of wireless communications system 100 or 300. For example, process flow 600 may be implemented by UEs 115-d and 115-e, which may each represent an example of a UE 115 described with reference to FIGS. 1-5. Process flow 600 may be implemented by UEs 115-d and 115-e, for example, to select resources for a sidelink message using multiple CCs of a set of candidate CCs, as described with reference to FIG. 3.

In the following description of process flow 600, the operations may be performed in a different order than the order shown, or the operations performed by UEs 115-d and 115-e may be performed in different orders or at different times. For example, specific operations may also be left out of process flow 600, or other operations may be added to process flow 600. Although UEs 115-d and 115-e are shown performing the operations of process flow 600, some aspects of some operations may also be performed by one or more other wireless devices.

At 605, UE 115-d may receive (e.g., from one or more other UEs, including UE 115-e) sidelink communications. The sidelink communications may include information (e.g., SCI) indicating resources reserved by other UEs 115 (e.g., UE 115-e) communicating on the sidelink. UE 115-d may receive the sidelink communications, may identify reserved or busy resources, and may use this information to select resources for a sidelink message.

At 610, UE 115-d may determine a resource selection configuration that indicates a set of CCs for sidelink communications within a shared radio frequency spectrum band. The resource selection configuration may, for example, indicate the set of CCs and one or more resource selection schemes for selecting resources within the set of CCs. For example, the resource selection configuration may indicate one or more rules for selecting resources within a transmission time occasion, as described herein with reference FIG. 5. The resource selection configuration may additionally or alternatively indicate whether UE 115-d is to transmit the sidelink message using one or more multiple CCs.

At 615, UE 115-d may select a transmission time occasion (e.g., one or multiple transmission time occasions) that has a frequency resource available on multiple CCs of the set of CCs, based on the resource selection configuration. For example, UE 115-d may select the transmission time occasion using the one or more rules for selecting resources.

At 620, UE 115-d may perform, prior to the transmission time occasion, a channel access procedure on each of the multiple CCs to determine whether each of the multiple CCs, or a respective frequency resource of each of the multiple CCs, is available. In some cases, the channel access procedure may indicate that one of the multiple CCs, or a respective frequency resource on one CC of the multiple CCs, is available (e.g., the channel access procedure may indicate that at least the one CC is idle). In some cases, the channel access procedure may indicate that two or more CCs of the multiple CCs, or a respective frequency resource on two or more CCs of the multiple CCs, is available. In some examples, UE 115-d may select one of the two or more CCs for transmitting the first sidelink message, for example, as described herein with reference to FIG. 4.

At 625, UE 115-d may transmit (e.g., broadcast or groupcast to UE 115-e and other UEs 115), during the transmission time occasion, a first sidelink message (e.g., a TB) within a corresponding frequency resource of at least one of the multiple CCs within the shared radio frequency spectrum band based on the channel access procedure (e.g., based on a channel access success). As described herein, UE 115-d may transmit the first sidelink message on one CC of the multiple CCs or on two or more CCs of the multiple CCs. The first sidelink message (e.g., TB) may be carried in a PSSCH.

In some cases, at 630, UE 115-d may transmit (e.g., broadcast or groupcast to UE 115-e and other UEs 115) a resource reservation message indicating a resource allocation for two or more CCs of the multiple CCs. A resource reservation message may represent or include a message transmitted (e.g., broadcast) by UE 115-d indicating one or more sidelink resources reserved for a sidelink transmission by UE 115-d in a future transmission time occasion. The resource reservation message may represent, for example, SCI that is broadcast together with the first sidelink message, or broadcast with another sidelink message, or broadcast in a standalone manner. A resource allocation may represent a time location and/or a frequency location of the resources reserved by the resource reservation message, for example, as described herein with reference to FIG. 4. The resource allocation may be for a future transmission time occasion, which may correspond to the indicated time location of the reserved resources. In some cases, the resource reservation message may be transmitted with the first sidelink message, or with another sidelink message.

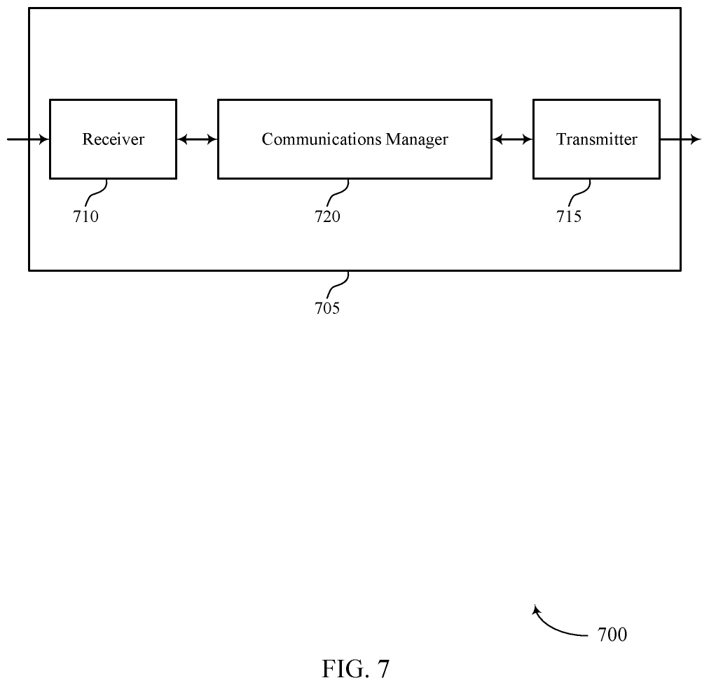

FIG. 7 shows a block diagram 700 of a device 705 that supports sidelink resource selection in unlicensed spectrum in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to sidelink resource selection in unlicensed spectrum). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to sidelink resource selection in unlicensed spectrum). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of sidelink resource selection in unlicensed spectrum as described herein. For example, the communications manager 720, the receiver 710, the transmitter 715, or various combinations or components thereof may support a method for performing one or more of the functions described herein.

The communications manager 720 may be an example of means for performing various aspects of managing sidelink resources as described herein. In some examples, the communications manager 720, the receiver 710, the transmitter 715, or various combinations or components thereof may be implemented in hardware (e.g., in communications management circuitry). The circuitry may comprise of a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

In another implementation, the communications manager 720, the receiver 710, the transmitter 715, or various combinations or components thereof may be implemented in code (e.g., as communications management software or firmware) executed by a processor, or any combination thereof. If implemented in code executed by a processor, the functions of the communications manager 720, the receiver 710, the transmitter 715, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting, determining, selecting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. For example, the communications manager 720 may be configured as or otherwise support a means for determining a resource selection configuration that indicates a set of multiple CCs for sidelink communications within a shared radio frequency spectrum band. The communications manager 720 may be configured as or otherwise support a means for selecting a transmission time occasion that has a frequency resource available on multiple CCs of the set of multiple CCs based on the resource selection configuration. The communications manager 720 may be configured as or otherwise support a means for performing, prior to the transmission time occasion, a channel access procedure on each of the multiple CCs to determine whether a respective frequency resource of each of the multiple CCs is available. The communications manager 720 may be configured as or otherwise support a means for transmitting, during the transmission time occasion, a first sidelink message within a corresponding frequency resource of at least one of the multiple CCs within the shared radio frequency spectrum band based on the channel access procedure.

The actions performed by the communications manager 720, among other examples herein, may be implemented to increase available battery power and communication quality at a wireless device (e.g., a UE 115) by supporting selection of sidelink resources across multiple CCs. The increase in communication quality may result in increased link performance and decreased overhead based on the selected sidelink resources. Accordingly, communications manager 720 may save power and increase battery life at a wireless device (e.g., a UE 115) by strategically increasing a quality of communications at a wireless device (e.g., a UE 115).

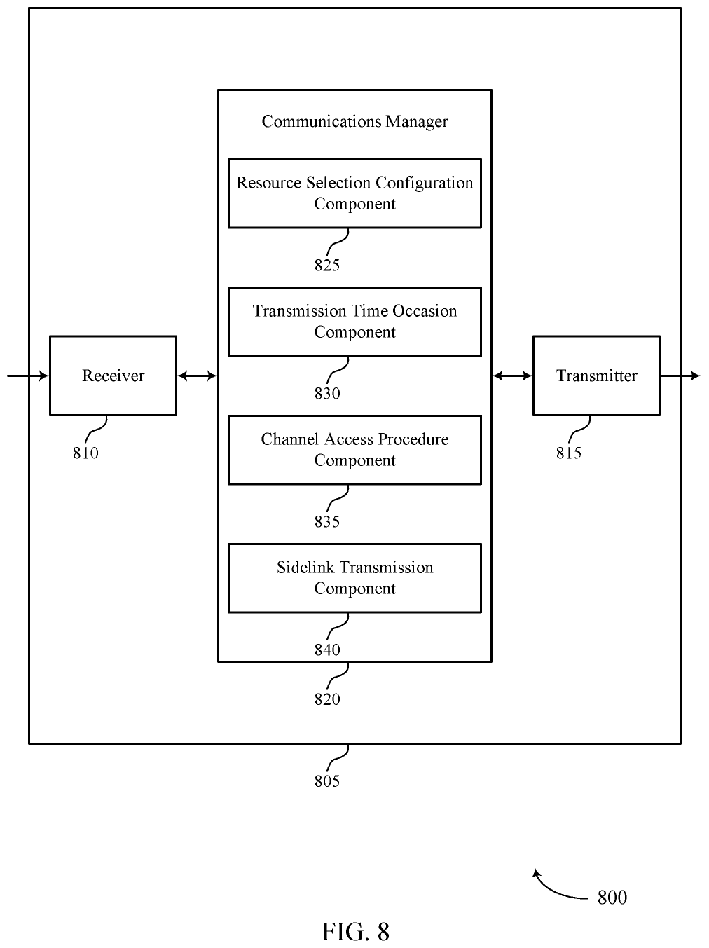

FIG. 8 shows a block diagram 800 of a device 805 that supports sidelink resource selection in unlicensed spectrum in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to sidelink resource selection in unlicensed spectrum). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to sidelink resource selection in unlicensed spectrum). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of sidelink resource selection in unlicensed spectrum as described herein. For example, the communications manager 820 may include a resource selection configuration component 825, a transmission time occasion component 830, a channel access procedure component 835, a sidelink transmission component 840, or any combination thereof. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a UE in accordance with examples as disclosed herein. The resource selection configuration component 825 may be configured as or otherwise support a means for determining a resource selection configuration that indicates a set of multiple CCs for sidelink communications within a shared radio frequency spectrum band. The transmission time occasion component 830 may be configured as or otherwise support a means for selecting a transmission time occasion that has a frequency resource available on multiple CCs of the set of multiple CCs based on the resource selection configuration. The channel access procedure component 835 may be configured as or otherwise support a means for performing, prior to the transmission time occasion, a channel access procedure on each of the multiple CCs to determine whether a respective frequency resource of each of the multiple CCs is available. The sidelink transmission component 840 may be configured as or otherwise support a means for transmitting, during the transmission time occasion, a first sidelink message within a corresponding frequency resource of at least one of the multiple CCs within the shared radio frequency spectrum band based on the channel access procedure.

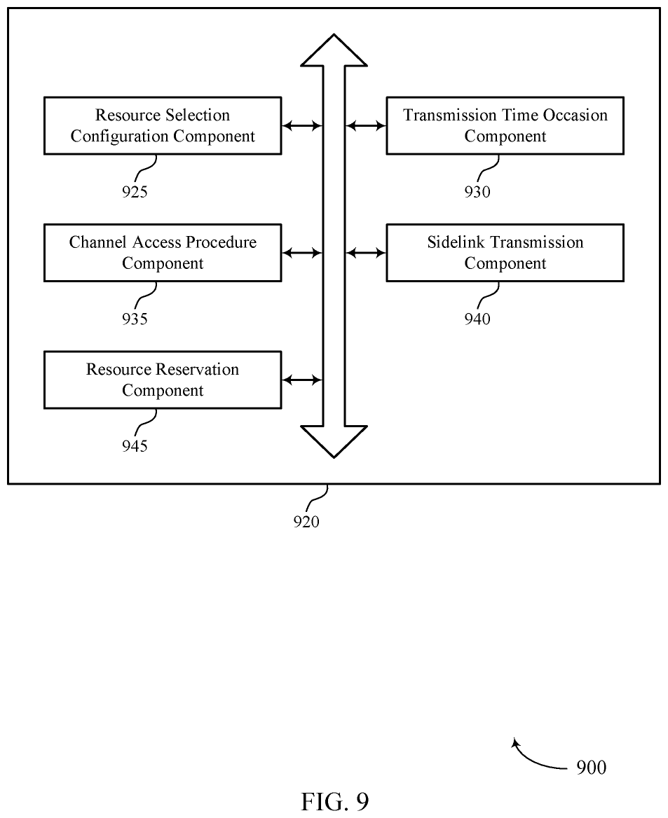

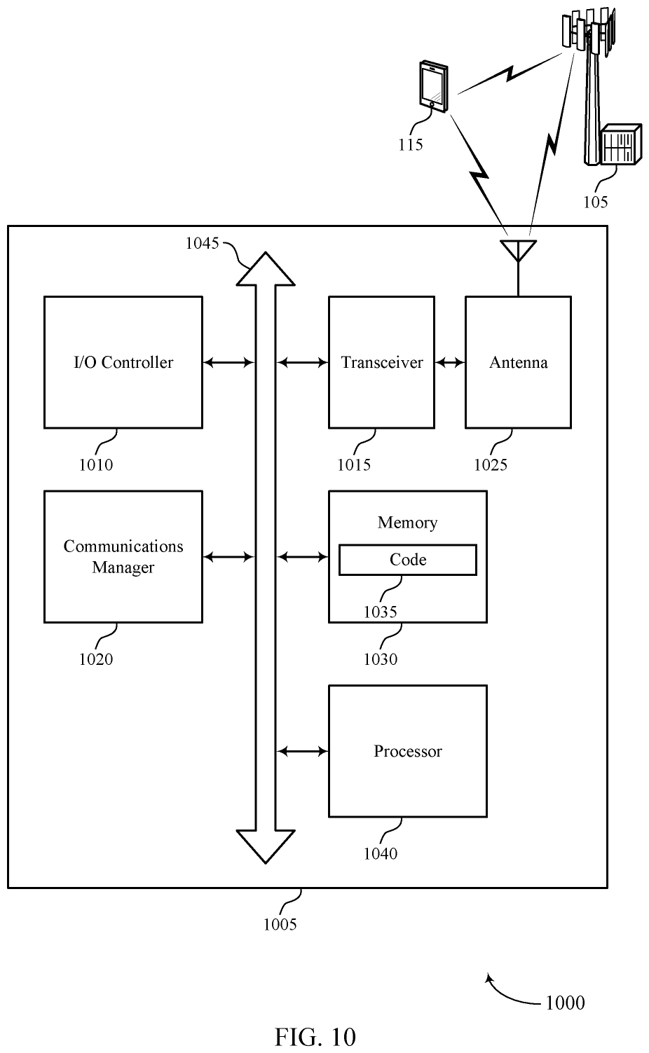

A processor of a wireless device (e.g., controlling the receiver 810, the transmitter 815, or the transceiver 1015 as described with reference to FIG. 10) may increase available battery power and communication quality. The increased communication quality may increase available battery power and throughput (e.g., via implementation of system components described with reference to FIG. 9) compared to other systems and techniques, for example, that do not support sidelink resource selection across multiple CCs, which may decrease communication quality and increase power consumption. Further, the processor of the wireless device may identify one or more aspects of a resource selection configuration to perform the sidelink resource selection. The processor of the wireless device may use the resource selection configuration to perform one or more actions that may result in increased communication quality, as well as save power and increase battery life at the wireless device (e.g., by strategically supporting increased communication quality by using selected sidelink resources), among other examples.

FIG. 9 shows a block diagram 900 of a communications manager 920 that supports sidelink resource selection in unlicensed spectrum in accordance with one or more aspects of the present disclosure. The communications manager 920 may be an example of aspects of a communications manager 720, a communications manager 820, or both, as described herein. The communications manager 920, or various components thereof, may be an example of means for performing various aspects of sidelink resource selection in unlicensed spectrum as described herein. For example, the communications manager 920 may include a resource selection configuration component 925, a transmission time occasion component 930, a channel access procedure component 935, a sidelink transmission component 940, a resource reservation component 945, or any combination thereof. Each of these components may communicate, directly or indirectly, with one another (e.g., via one or more buses).

The communications manager 920 may support wireless communication at a UE in accordance with examples as disclosed herein. The resource selection configuration component 925 may be configured as or otherwise support a means for determining a resource selection configuration that indicates a set of multiple CCs for sidelink communications within a shared radio frequency spectrum band. The transmission time occasion component 930 may be configured as or otherwise support a means for selecting a transmission time occasion that has a frequency resource available on multiple CCs of the set of multiple CCs based on the resource selection configuration.

The channel access procedure component 935 may be configured as or otherwise support a means for performing, prior to the transmission time occasion, a channel access procedure on each of the multiple CCs to determine whether a respective frequency resource of each of the multiple CCs is available. The sidelink transmission component 940 may be configured as or otherwise support a means for transmitting, during the transmission time occasion, a first sidelink message within a corresponding frequency resource of at least one of the multiple CCs within the shared radio frequency spectrum band based on the channel access procedure.

In some examples, the resource reservation component 945 may be configured as or otherwise support a means for transmitting a resource reservation message indicating a resource allocation for two or more CCs of the multiple CCs. In some examples, the resource reservation component 945 may be configured as or otherwise support a means for transmitting the resource reservation message indicating a corresponding carrier index of the two or more CCs and a respective frequency location for the resource allocation in each of the two or more CCs.

In some examples, the resource reservation component 945 may be configured as or otherwise support a means for transmitting the resource reservation message indicating a corresponding carrier index of the two or more CCs and a same frequency location for the resource allocation within a respective bandwidth of each of the two or more CCs. In some examples, the resource reservation component 945 may be configured as or otherwise support a means for transmitting the resource reservation message indicating all of the set of multiple CCs and indicating a same frequency location within a respective bandwidth of each of the multiple CCs.

In some examples, the resource reservation component 945 may be configured as or otherwise support a means for transmitting the resource reservation message via the first sidelink message, the resource allocation indicating resources in the two or more CCs for a second sidelink message. In some examples, the resource reservation component 945 may be configured as or otherwise support a means for transmitting the resource reservation message indicating the resource allocation that indicates a time location of the transmission time occasion in the two or more CCs.

In some examples, the sidelink transmission component 940 may be configured as or otherwise support a means for transmitting, during the transmission time occasion, the first sidelink message on two or more CCs of the multiple CCs within the shared radio frequency spectrum band.

In some examples, the transmission time occasion component 930 may be configured as or otherwise support a means for selecting the transmission time occasion that has a frequency resource available on each CC of the set of multiple CCs based on the resource selection configuration. In some examples, the transmission time occasion component 930 may be configured as or otherwise support a means for selecting the transmission time occasion that has a frequency resource available at a same frequency location within a respective bandwidth of each CC of the multiple CCs based on the resource selection configuration. In some examples, the multiple CCs include all of the set of multiple CCs.

In some examples, the channel access procedure component 935 may be configured as or otherwise support a means for performing the channel access procedure that indicates the respective frequency resource of two or more CCs of the multiple CCs is available. In some examples, the channel access procedure component 935 may be configured as or otherwise support a means for selecting a first CC of the two or more CCs for transmitting the first sidelink message based on the channel access procedure. In some examples, the channel access procedure includes an LBT procedure. In some examples, the channel access procedure includes an energy detection procedure.

FIG. 10 shows a diagram of a system 1000 including a device 1005 that supports sidelink resource selection in unlicensed spectrum in accordance with one or more aspects of the present disclosure. The device 1005 may be an example of or include the components of a device 705, a device 805, or a UE 115 as described herein. The device 1005 may communicate wirelessly with one or more base stations 105, UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting sidelink resource selection in unlicensed spectrum). For example, the device 1005 or a component of the device 1005 may include a processor 1040 and memory 1030 coupled to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for determining a resource selection configuration that indicates a set of multiple CCs for sidelink communications within a shared radio frequency spectrum band. The communications manager 1020 may be configured as or otherwise support a means for selecting a transmission time occasion that has a frequency resource available on multiple CCs of the set of multiple CCs based on the resource selection configuration. The communications manager 1020 may be configured as or otherwise support a means for performing, prior to the transmission time occasion, a channel access procedure on each of the multiple CCs to determine whether a respective frequency resource of each of the multiple CCs is available. The communications manager 1020 may be configured as or otherwise support a means for transmitting, during the transmission time occasion, a first sidelink message within a corresponding frequency resource of at least one of the multiple CCs within the shared radio frequency spectrum band based on the channel access procedure.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of sidelink resource selection in unlicensed spectrum as described herein, or the processor 1040 and the memory 1030 may be otherwise configured to perform or support such operations.

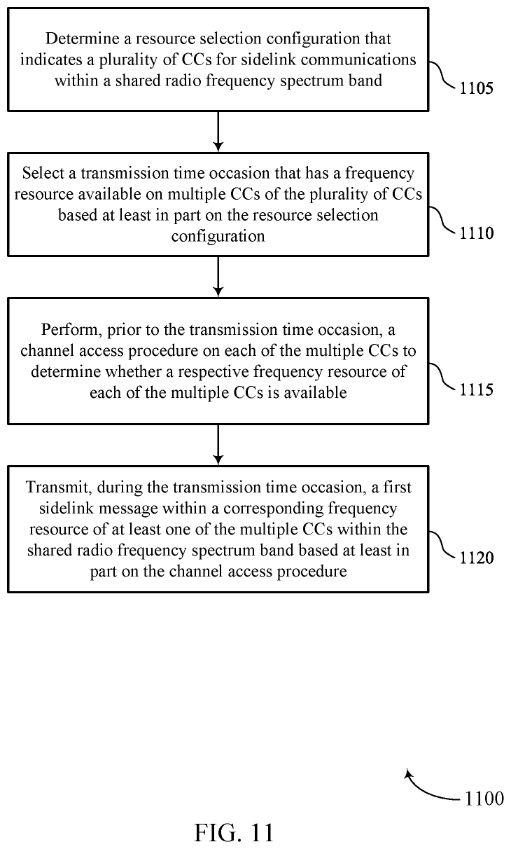

FIG. 11 shows a flowchart illustrating a method 1100 that supports sidelink resource selection in unlicensed spectrum in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1105, the method may include determining a resource selection configuration that indicates a set of multiple CCs for sidelink communications within a shared radio frequency spectrum band. The operations of 1105 may be performed in accordance with examples as disclosed herein. In some examples, aspects of the operations of 1105 may be performed by a resource selection configuration component 925 as described with reference to FIG. 9.

At 1110, the method may include selecting a transmission time occasion that has a frequency resource available on multiple CCs of the set of multiple CCs based on the resource selection configuration. The operations of 1110 may be performed in accordance with examples as disclosed herein. In some examples, aspects of the operations of 1110 may be performed by a transmission time occasion component 930 as described with reference to FIG. 9.

At 1115, the method may include performing, prior to the transmission time occasion, a channel access procedure on each of the multiple CCs to determine whether a respective frequency resource of each of the multiple CCs is available. The operations of 1115 may be performed in accordance with examples as disclosed herein. In some examples, aspects of the operations of 1115 may be performed by a channel access procedure component 935 as described with reference to FIG. 9.

At 1120, the method may include transmitting, during the transmission time occasion, a first sidelink message within a corresponding frequency resource of at least one of the multiple CCs within the shared radio frequency spectrum band based on the channel access procedure. The operations of 1120 may be performed in accordance with examples as disclosed herein. In some examples, aspects of the operations of 1120 may be performed by a sidelink transmission component 940 as described with reference to FIG. 9.

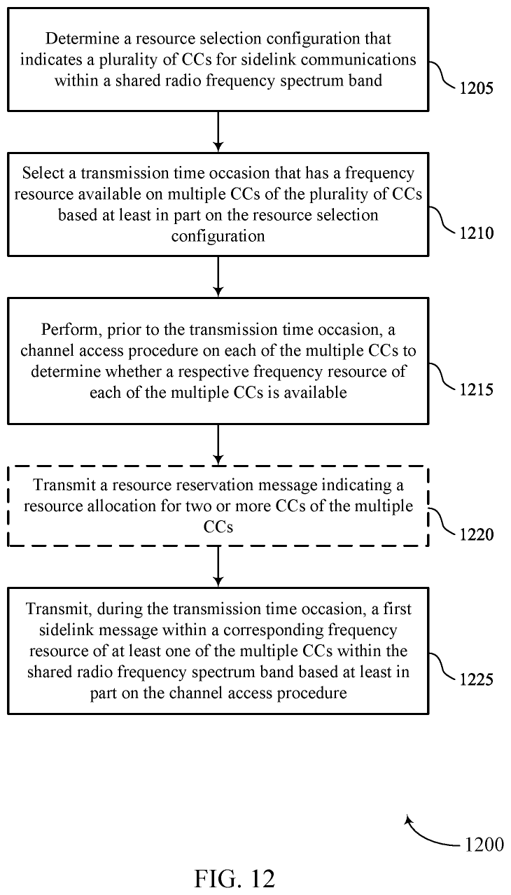

FIG. 12 shows a flowchart illustrating a method 1200 that supports sidelink resource selection in unlicensed spectrum in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1205, the method may include determining a resource selection configuration that indicates a set of multiple CCs for sidelink communications within a shared radio frequency spectrum band. The operations of 1205 may be performed in accordance with examples as disclosed herein. In some examples, aspects of the operations of 1205 may be performed by a resource selection configuration component 925 as described with reference to FIG. 9.

At 1210, the method may include selecting a transmission time occasion that has a frequency resource available on multiple CCs of the set of multiple CCs based on the resource selection configuration. The operations of 1210 may be performed in accordance with examples as disclosed herein. In some examples, aspects of the operations of 1210 may be performed by a transmission time occasion component 930 as described with reference to FIG. 9.

At 1215, the method may include performing, prior to the transmission time occasion, a channel access procedure on each of the multiple CCs to determine whether a respective frequency resource of each of the multiple CCs is available. The operations of 1215 may be performed in accordance with examples as disclosed herein. In some examples, aspects of the operations of 1215 may be performed by a channel access procedure component 935 as described with reference to FIG. 9.

At 1220, the method may include transmitting a resource reservation message indicating a resource allocation for two or more CCs of the multiple CCs. The operations of 1220 may be performed in accordance with examples as disclosed herein. In some examples, aspects of the operations of 1220 may be performed by a resource reservation component 945 as described with reference to FIG. 9.

At 1225, the method may include transmitting, during the transmission time occasion, a first sidelink message within a corresponding frequency resource of at least one of the multiple CCs within the shared radio frequency spectrum band based on the channel access procedure. The operations of 1225 may be performed in accordance with examples as disclosed herein. In some examples, aspects of the operations of 1225 may be performed by a sidelink transmission component 940 as described with reference to FIG. 9.

The following provides an overview of aspects of the present disclosure:

Aspect 1: A method for wireless communication at a UE, comprising: determining a resource selection configuration that indicates a plurality of CCs for sidelink communications within a shared radio frequency spectrum band; selecting a transmission time occasion that has a frequency resource available on multiple CCs of the plurality of CCs based at least in part on the resource selection configuration; performing, prior to the transmission time occasion, a channel access procedure on each of the multiple CCs to determine whether a respective frequency resource of each of the multiple CCs is available; and transmitting, during the transmission time occasion, a first sidelink message within a corresponding frequency resource of at least one of the multiple CCs within the shared radio frequency spectrum band based at least in part on the channel access procedure.

Aspect 2: The method of aspect 1, further comprising: transmitting a resource reservation message indicating a resource allocation for two or more CCs of the multiple CCs.

Aspect 3: The method of aspect 2, the transmitting the resource reservation message comprising: transmitting the resource reservation message indicating a corresponding carrier index of the two or more CCs and a respective frequency location for the resource allocation in each of the two or more CCs.

Aspect 4: The method of aspect 2, the transmitting the resource reservation message comprising: transmitting the resource reservation message indicating a corresponding carrier index of the two or more CCs and a same frequency location for the resource allocation within a respective bandwidth of each of the two or more CCs.

Aspect 5: The method of aspect 2, the transmitting the resource reservation message comprising: transmitting the resource reservation message indicating all of the plurality of CCs and indicating a same frequency location within a respective bandwidth of each of the multiple CCs.

Aspect 6: The method of any of aspects 2 through 5, the transmitting the resource reservation message comprising: transmitting the resource reservation message via the first sidelink message, the resource allocation indicating resources in the two or more CCs for a second sidelink message.

Aspect 7: The method of any of aspects 2 through 6, the transmitting the resource reservation message comprising: transmitting the resource reservation message indicating the resource allocation that indicates a time location of the transmission time occasion in the two or more CCs.

Aspect 8: The method of any of aspects 1 through 7, the transmitting the first sidelink message comprising: transmitting, during the transmission time occasion, the first sidelink message on two or more CCs of the multiple CCs within the shared radio frequency spectrum band.

Aspect 9: The method of any of aspects 1 through 8, the selecting the transmission time occasion comprising: selecting the transmission time occasion that has a frequency resource available on each CC of the plurality of CCs based at least in part on the resource selection configuration.

Aspect 10: The method of any of aspects 1 through 8, the selecting the transmission time occasion comprising: selecting the transmission time occasion that has a frequency resource available at a same frequency location within a respective bandwidth of each CC of the multiple CCs based at least in part on the resource selection configuration.

Aspect 11: The method of aspect 10, the multiple CCs including all of the plurality of CCs.

Aspect 12: The method of any of aspects 1 through 11, the performing the channel access procedure comprising: performing the channel access procedure that indicates the respective frequency resource of two or more CCs of the multiple CCs is available.

Aspect 13: The method of aspect 12, further comprising: selecting a first CC of the two or more CCs for transmitting the first sidelink message based at least in part on the channel access procedure.

Aspect 14: The method of any of aspects 1 through 13, the channel access procedure comprising a listen before talk procedure.

Aspect 15: The method of any of aspects 1 through 14, the channel access procedure comprising an energy detection procedure.

Aspect 16: An apparatus for wireless communication at a UE, comprising a processor and memory coupled to the processor, the processor and memory configured to perform a method of any of aspects 1 through 15.

Aspect 17: An apparatus for wireless communication at a UE, comprising at least one means for performing a method of any of aspects 1 through 15.

Aspect 18: A non-transitory computer-readable medium storing code for wireless communication at a UE, the code comprising instructions executable by a processor to perform a method of any of aspects 1 through 15.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor; and
memory coupled to the processor, the processor and memory configured to:
determine a resource selection configuration that indicates a plurality of component carriers for sidelink communications within a shared radio frequency spectrum band;
select a transmission time occasion that has a frequency resource available on multiple component carriers of the plurality of component carriers based at least in part on the resource selection configuration;
perform, prior to the transmission time occasion, a channel access procedure on each of the multiple component carriers to determine whether a respective frequency resource of each of the multiple component carriers is available; and
transmit, during the transmission time occasion, a first sidelink message within a corresponding frequency resource of at least one of the multiple component carriers within the shared radio frequency spectrum band based at least in part on the channel access procedure.

2. The apparatus of claim 1, further comprising an antenna, wherein the antenna, processor, and memory are configured to:
transmit a resource reservation message indicating an allocation of resources for two or more component carriers of the multiple component carriers.

3. The apparatus of claim 2, wherein, to transmit the resource reservation message, the processor and memory are configured to:
transmit the resource reservation message indicating a corresponding carrier index of the two or more component carriers and a respective frequency location for the resource allocation in each of the two or more component carriers.

4. The apparatus of claim 2, wherein, to transmit the resource reservation message, the processor and memory are configured to:
transmit the resource reservation message indicating a corresponding carrier index of the two or more component carriers and a same frequency location for the resource allocation within a respective bandwidth of each of the two or more component carriers.

5. The apparatus of claim 2, wherein, to transmit the resource reservation message, the processor and memory are configured to:
transmit the resource reservation message indicating all of the plurality of component carriers and indicating a same frequency location within a respective bandwidth of each of the multiple component carriers.

6. The apparatus of claim 2, wherein, to transmit the resource reservation message, the processor and memory are configured to:
transmit the resource reservation message via the first sidelink message, the resource allocation indicating resources in the two or more component carriers for a second sidelink message.

7. The apparatus of claim 2, wherein, to transmit the resource reservation message, the processor and memory are configured to:
transmit the resource reservation message indicating the resource allocation that indicates a time location of the transmission time occasion in the two or more component carriers.

8. The apparatus of claim 1, wherein, to transmit the first sidelink message, the processor and memory are configured to:
transmit, during the transmission time occasion, the first sidelink message on two or more component carriers of the multiple component carriers within the shared radio frequency spectrum band.

9. The apparatus of claim 1, wherein, to select the transmission time occasion, the processor and memory are configured to:
select the transmission time occasion that has a frequency resource available on each component carrier of the plurality of component carriers based at least in part on the resource selection configuration.

10. The apparatus of claim 1, wherein, to select the transmission time occasion, the processor and memory are configured to:
select the transmission time occasion that has a frequency resource available at a same frequency location within a respective bandwidth of each component carrier of the multiple component carriers based at least in part on the resource selection configuration.

11. The apparatus of claim 10, the multiple component carriers including all of the plurality of component carriers.

12. The apparatus of claim 1, wherein, to perform the channel access procedure, the processor and memory are configured to:
perform the channel access procedure that indicates the respective frequency resource of two or more component carriers of the multiple component carriers is available.

13. The apparatus of claim 12, wherein the processor and memory are further configured to:
select a first component carrier of the two or more component carriers for transmitting the first sidelink message based at least in part on the channel access procedure.

14. The apparatus of claim 1, the channel access procedure comprising a listen before talk procedure.

15. The apparatus of claim 1, the channel access procedure comprising an energy detection procedure.

16. A method for wireless communication at a user equipment (UE), comprising:
determining a resource selection configuration that indicates a plurality of component carriers for sidelink communications within a shared radio frequency spectrum band;
selecting a transmission time occasion that has a frequency resource available on multiple component carriers of the plurality of component carriers based at least in part on the resource selection configuration;
performing, prior to the transmission time occasion, a channel access procedure on each of the multiple component carriers to determine whether a respective frequency resource of each of the multiple component carriers is available; and
transmitting, during the transmission time occasion, a first sidelink message within a corresponding frequency resource of at least one of the multiple component carriers within the shared radio frequency spectrum band based at least in part on the channel access procedure.

17. The method of claim 16, further comprising:
transmitting a resource reservation message indicating an allocation of resources for two or more component carriers of the multiple component carriers.

18. The method of claim 17, the transmitting the resource reservation message comprising:
transmitting the resource reservation message indicating a corresponding carrier index of the two or more component carriers and a respective frequency location for the resource allocation in each of the two or more component carriers.

19. The method of claim 17, the transmitting the resource reservation message comprising:
transmitting the resource reservation message indicating a corresponding carrier index of the two or more component carriers and a same frequency location for the resource allocation within a respective bandwidth of each of the two or more component carriers.

20. The method of claim 17, the transmitting the resource reservation message comprising:
transmitting the resource reservation message indicating all of the plurality of component carriers and indicating a same frequency location within a respective bandwidth of each of the multiple component carriers.

21. The method of claim 17, the transmitting the resource reservation message comprising:
transmitting the resource reservation message via the first sidelink message, the resource allocation indicating resources in the two or more component carriers for a second sidelink message.

22. The method of claim 17, the transmitting the resource reservation message comprising:
transmitting the resource reservation message indicating the resource allocation that indicates a time location of the transmission time occasion in the two or more component carriers.

23. The method of claim 16, the transmitting the first sidelink message comprising:
transmitting, during the transmission time occasion, the first sidelink message on two or more component carriers of the multiple component carriers within the shared radio frequency spectrum band.

24. The method of claim 16, the selecting the transmission time occasion comprising:
selecting the transmission time occasion that has a frequency resource available on each component carrier of the plurality of component carriers based at least in part on the resource selection configuration.

25. The method of claim 16, the selecting the transmission time occasion comprising:
selecting the transmission time occasion that has a frequency resource available at a same frequency location within a respective bandwidth of each component carrier of the multiple component carriers based at least in part on the resource selection configuration.

26. The method of claim 25, the multiple component carriers including all of the plurality of component carriers.

27. The method of claim 16, the performing the channel access procedure comprising:
performing the channel access procedure that indicates the respective frequency resource of two or more component carriers of the multiple component carriers is available.

28. The method of claim 27, further comprising:
selecting a first component carrier of the two or more component carriers for transmitting the first sidelink message based at least in part on the channel access procedure.

29. An apparatus for wireless communication at a user equipment (UE), comprising:
means for determining a resource selection configuration that indicates a plurality of component carriers for sidelink communications within a shared radio frequency spectrum band;
means for selecting a transmission time occasion that has a frequency resource available on multiple component carriers of the plurality of component carriers based at least in part on the resource selection configuration;
means for performing, prior to the transmission time occasion, a channel access procedure on each of the multiple component carriers to determine whether a respective frequency resource of each of the multiple component carriers is available; and
means for transmitting, during the transmission time occasion, a first sidelink message within a corresponding frequency resource of at least one of the multiple component carriers within the shared radio frequency spectrum band based at least in part on the channel access procedure.

30. A non-transitory computer-readable medium storing code for wireless communication at a user equipment (UE), the code comprising instructions executable by a processor to:
determine a resource selection configuration that indicates a plurality of component carriers for sidelink communications within a shared radio frequency spectrum band;
select a transmission time occasion that has a frequency resource available on multiple component carriers of the plurality of component carriers based at least in part on the resource selection configuration;
perform, prior to the transmission time occasion, a channel access procedure on each of the multiple component carriers to determine whether a respective frequency resource of each of the multiple component carriers is available; and
transmit, during the transmission time occasion, a first sidelink message within a corresponding frequency resource of at least one of the multiple component carriers within the shared radio frequency spectrum band based at least in part on the channel access procedure.
